(19) United States
(12) Patent Application Publication
(10) Pub. No.: US 2026/0042651 A1
(43) Pub. Date: Feb. 12, 2026

(54) BARREL UNBUNGING APPARATUS

(71) Applicant: LINE-INDUSTRY Co.,Ltd., Komaki-shi (JP)

(72) Inventor: Kenji NAKAI, Komaki-shi (JP)

(21) Appl. No.: 19/294,825

(22) Filed: Aug. 8, 2025

(30) Foreign Application Priority Data
Aug. 8, 2024 (JP) 2024-133209
Jun. 20, 2025 (JP) 2025-104472

(51) Int. Cl. B67B 7/42

(52) U.S. Cl. CPC B67B 7/42

(57) ABSTRACT

A barrel unbunging apparatus configured to pull out a barrel plug from a barrel placed in a laterally-oriented state on a conveyor of a conveyance line. The barrel unbunging apparatus includes a lifting-and-rotating unit, a barrel plug detection unit, and an unbunging unit. The lifting-and-rotating unit is configured to rotate the barrel in a state where the barrel has been lifted above the conveyor. The barrel plug detection unit is configured to detect a position of the barrel plug. The unbunging unit has an end provided with a drill configured to pull out the barrel plug.

### CROSS-REFERENCE TO RELATED APPLICATION

This application claims priority from Japanese Patent Application Nos. 2024-133209 filed with the Japan Patent Office on Aug. 8, 2024, and 2025-104472 filed with the Japan Patent Office on Jun. 20, 2025, the entire content of which is hereby incorporated by reference.

### BACKGROUND

### 1. Technical Field

The present invention relates to an unbunging apparatus that automatically performs unbunging as preparatory work before drawing out contents (remaining liquid) from a barrel (mainly whiskey barrel) placed in a laterally-oriented state on a conveyor in order to be conveyed.

### 2. Related Art

In order to contain, for example, liquors such as whiskey and wine, barrels (columnar containers having, in a height direction thereof, middle portions bulged outward) made of wood are widely used as containers since such barrels inflict favorable influence on the tastes and the aromas of the contents thereof.

Also, in production of whiskey, wine, etc., a step called aging (barrel aging) for storing the whiskey, the wine, etc. in a state of being contained in barrels for a certain period is employed for the purpose of, for example, finishing the whiskey, the wine, etc. with richness in flavor. Therefore, in a factory for producing whiskey, wine, etc., barrels need to be conveyed from a warehouse in which aging has been performed, and the liquors (aged liquors) need to be ejected (drawn out) from inside the barrels, or liquors (newly-made liquors) need to be injected into the barrels (the barrels need to be filled therewith) in order to newly perform aging. Each of such barrels has a maximally-bulged portion at the center thereof in the height direction. In the maximally-bulged portion, a barrel hole (so-called bung hole) is drilled. Through the barrel hole, work for ejecting a liquor from inside the barrel and work for injecting a liquor into the barrel needs to be performed.

In order to facilitate the above-described work for conveying a barrel, the above-described work for ejecting a liquor from inside the barrel, and the above-described work for injecting a liquor into the barrel, attempts have been made to automate the production process. For example, a barrel liquid-filling/draw-out system is proposed in JP-A-2003-034408. The barrel liquid-filling/draw-out system includes: a work unit which fills barrels with liquids and draws out the liquids; and a conveyance apparatus which automatically conveys the barrels between the work unit and racks stacked in a plurality of stages to store the barrels in three-dimensional arrangement.

According to the above-described barrel liquid-filling/draw-out system in JP-A-2003-034408, each of the barrels is automatically conveyed from the corresponding rack on which the barrel is stored to the work unit at which liquid-filling/draw-out work is to be performed. Thus, it becomes unnecessary for a worker to go to the place in which the barrel is stored and to convey the barrel to a liquor ejection/injection area. Therefore, a series of work operations is made efficient.

However, since the work for ejecting a liquor from inside a barrel and the work for injecting a liquor into the barrel need to be performed through the barrel hole as described above, the above-described barrel liquid-filling/draw-out system in JP-A-2003-034408 makes it necessary for a worker to, for each of barrels conveyed to the liquor ejection/injection area, laterally lay down the barrel, pull out a barrel plug squeezed into the barrel hole, and insert, into the barrel hole, an apparatus for ejecting a liquor from inside or an apparatus for injecting a liquor to the inside. Therefore, the barrel liquid-filling/draw-out system in JP-A-2003-034408 does not necessarily lead to efficient work.

In addition, sizes (height, diameter, and the like) differ among liquor barrels (especially, whiskey barrels) (standards are not unified), and thus unbunging work is difficult to automate.

An object of the present invention is to provide a barrel automatic unbunging apparatus that solves the drawbacks of conventional liquor production systems such as the above-described barrel liquid-filling/draw-out system in JP-A-2003-034408 and that can facilitate work for ejecting a liquor from inside a barrel and work for injecting a liquor into the barrel.

### SUMMARY

In order to solve the above-described problem, the invention according to a first aspect is a barrel unbunging apparatus configured to pull out a barrel plug from a barrel placed in a laterally-oriented state on a conveyor of a conveyance line. The barrel unbunging apparatus includes a lifting-and-rotating unit, a barrel plug detection unit, and an unbunging unit. The lifting-and-rotating unit is configured to rotate the barrel in a state where the barrel has been lifted above the conveyor. The barrel plug detection unit is configured to detect a position of the barrel plug. The unbunging unit has an end provided with a drill configured to pull out the barrel plug. In the present specification, a lateral direction of the barrel means a longitudinal direction of the barrel. A rotation direction of the barrel means a direction perpendicular to the lateral direction of the barrel. A center in the lateral direction of the barrel means a plane (circle) formed by a trajectory of the barrel plug (and a barrel hole) when the barrel is rotated. A center in the rotation direction of the barrel means a plane (vertical plane) including a rotation axis about which the barrel is rotated.

The invention according to a second aspect, which is in the invention according to the first aspect, further includes a pressing-and-holding unit configured to press the barrel to prevent the barrel from being lifted together with the drill when the barrel plug is being pulled out by the drill.

The invention according to a third aspect, which is in the invention according to the first aspect, further includes a centering unit configured to detect a center in a lateral direction of the barrel and a center in a rotation direction of the barrel in a state where the lifting-and-rotating unit has lifted the barrel above the conveyor and has rotated the barrel.

In the invention according to a fourth aspect, which is in the invention according to the first aspect, the drill has a narrowing angle adjusted to 0 to 3°. The shape of the drill in the present invention is not particularly limited, but the drill is preferably of a screw type in which a substantially strip-shaped drill blade is helically wound along an axis such that the drill is tapered from the base end toward the point thereof. In the present specification, the narrowing angle means the angle at the point of a cone formed by imaginarily connecting the lands (outermost end edges) of the drill blade helically wound along the axis (i.e., the angle of a portion at which an imaginary line mutually connecting the lands on one side of the drill blade and an imaginary line mutually connecting the lands on the opposite side of the drill blade intersect with each other in a side view of the drill) (see FIG. 3).

In the invention according to a fifth aspect, which is in the invention according to the second aspect, the pressing-and-holding unit presses the barrel in a direction (downward direction) opposite to a direction (upward direction) in which the barrel plug is pulled out by the drill, the pressing inhibiting the barrel from being lifted.

In the barrel unbunging apparatus (hereinafter, simply referred to as “unbunging apparatus”) according to the first aspect, the barrel plug whose position has been detected by the barrel plug detection unit can be pulled out from the barrel by the drill in a state where the lifting-and-rotating unit has lifted the barrel above the conveyor and has rotated the barrel. Consequently, the barrel unbunging apparatus according to the first aspect makes it possible to automatically pull out the barrel plug from the barrel without need for work by a worker, whereby barreling work and draw-out work can be efficiently performed in a production process for a liquor (such as whiskey).

The unbunging apparatus according to the second aspect includes the pressing-and-holding unit configured to press the barrel to prevent the barrel from being lifted together with the drill when the barrel plug is being pulled out by the drill. Consequently, the barrel plug can be pulled out from the barrel smoothly with high accuracy without allowing occurrence of, for example, displacement of the barrel in association with unbunging work.

The unbunging apparatus according to the third aspect includes the centering unit configured to detect the center in the lateral direction of the barrel and the center in the rotation direction of the barrel in a state where the barrel has been lifted above the conveyor and rotated. Consequently, even in a case where the sizes differ among barrels which are conveyed, the barrel plug detection unit can accurately detect the position of each of the barrel plugs thereof, whereby the drill can be assuredly stuck into (pressed against) the barrel plug with higher accuracy.

In the unbunging apparatus according to the fourth aspect, the drill has a narrowing angle adjusted to 0 to 3°. Consequently, the drill can be smoothly caused to bite into the barrel plug, whereby the barrel plug can be assuredly pulled out from the barrel with higher accuracy.

In the unbunging apparatus according to the fifth aspect, the pressing-and-holding unit presses the barrel in the direction (downward direction) opposite to the direction (upward direction) in which the barrel plug is pulled out by the drill, the pressing inhibiting the barrel from being lifted. Consequently, the barrel plug can be assuredly pulled out from the barrel considerably smoothly with extremely high accuracy without allowing occurrence of, for example, displacement of the barrel in association with unbunging work.

### BRIEF DESCRIPTION OF DRAWINGS

FIG. 1 is an explanatory view (plan view) illustrating a conveyance apparatus;

FIG. 2 is an explanatory view (left side view) illustrating an unbunging preparation device;

FIG. 3 is an explanatory view (left side view) illustrating a barrel plug pull-out device;

FIG. 4 is an explanatory view (front view) illustrating an end portion of an unbunging unit;

FIG. 5 is an explanatory view (left side view) illustrating details of operation of the unbunging preparation device;

FIG. 6 is an explanatory view (left side view) illustrating the details of the operation of the unbunging preparation device;

FIG. 7 is an explanatory view (rear view) illustrating the details of the operation of the unbunging preparation device; and

FIG. 8 is an explanatory view (front view) illustrating details of operation of the barrel plug pull-out device.

### DETAILED DESCRIPTION

### <Configuration of Conveyance Apparatus>

Hereinafter, one embodiment of an unbunging apparatus according to the present invention and a conveyance apparatus including the unbunging apparatus will be described in detail with reference to the drawings. If a liquor barrel for whiskey or the like is excessively dry, a gap is easily formed between staves thereof. Consequently, when whiskey or the like is barreled, the content easily leaks. Considering this, the liquor barrel is bunged and stored in a state where water or the like is poured therein to expand the staves and prevent formation of a gap. Thus, at the time of barreling whiskey or the like, the liquor barrel needs to be unbunged to discharge the internal water or the like, then filled with whiskey, and conveyed to a storage or the like for aging.

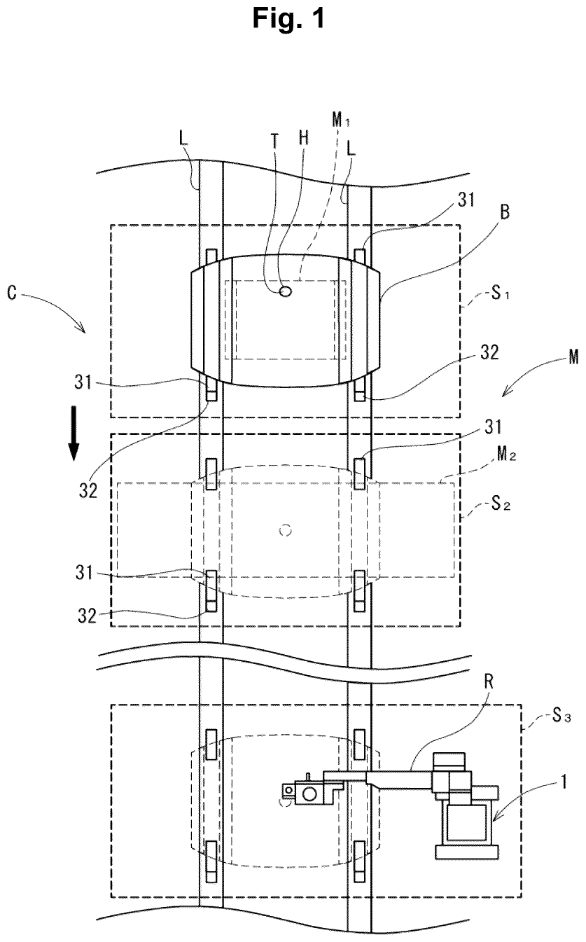

FIG. 1 illustrates an example of the conveyance apparatus (conveyance apparatus for a liquor barrel for whiskey or the like) mounted with the unbunging apparatus. A liquor barrel B to be conveyed by a conveyance apparatus C is formed into a columnar shape with a central portion thereof being bulged outward by fitting staves together. The liquor barrel B has a side surface (also referred to as “circumferential surface” or “bilge”) substantially at the center thereof in a height direction. In the side surface, a barrel hole H (so-called bung hole) to be used for injecting and ejecting contents is drilled. Into the barrel hole H, a barrel plug T (also referred to as a bung plug or bung) made of wood or plastic is squeezed so that the inside of the barrel B is in a sealed state. The conveyance apparatus C is for: conveying each of such barrels (liquor barrels) B which are in laterally laid-down states; pulling out the barrel plug T at a predetermined place; then conveying the barrel to a different place; and injecting a liquid (newly-made liquor) into the barrel (or ejecting a liquid (aged liquor) from inside the barrel).

An unbunging apparatus M which removes the barrel plug T from the barrel B laterally laid down on conveyance lines L of a chain conveyor type (laterally laid down such that the height direction is orthogonal to a conveyance direction) is installed on an upstream side of the conveyance apparatus C. Also, an injecting/ejecting apparatus 1 which injects a liquid (newly-made liquor) into the barrel or ejects a liquid (aged liquor) from inside the barrel is installed on a downstream side of the unbunging apparatus M. The injecting/ejecting apparatus 1 is configured to actuate a four-axis articulated robot arm R based on control by a controller (not illustrated), thereby being able to: inject a liquid (newly-made liquor or the like) inside a filling liquid tank (not illustrated) into the barrel B; or eject a liquid (aged liquor or the like) inside the barrel B to a collection liquid tank (not illustrated).

The conveyance lines L are provided with reception claw members 31 for fixing the laterally laid-down barrels B. The reception claw members 31 are provided at an equal pitch along a longitudinal direction at predetermined intervals in front-rear and left-right directions such that every four of the reception claw members 31 correspond to one of the barrels B. The reception claw members 31 are grouped into sets each composed of two left reception claw members 31 and two right reception claw members 31. The left and right reception claw members 31 are in a state of being tilted downward from an outer side toward an inner side such that the upper surfaces thereof come into contact with the circumferential surface of the barrel B. Furthermore, among the reception claw members 31 composing each of the sets, reception claw members 31 located on the downstream side have front surfaces provided with respective positioning members 32.

Furthermore, an area of the conveyance lines L in which the unbunging apparatus M is installed. The area is divided into: a detection station S1 in which the position of the barrel plug T of the barrel B is detected, and the barrel B is subjected to position matching (position adjustment) while being rotated such that the barrel plug T faces directly upward; and an unbunging station S2 in which the barrel plug T of the barrel B subjected to position matching is pulled out.

### <Configuration of Unbunging Apparatus>

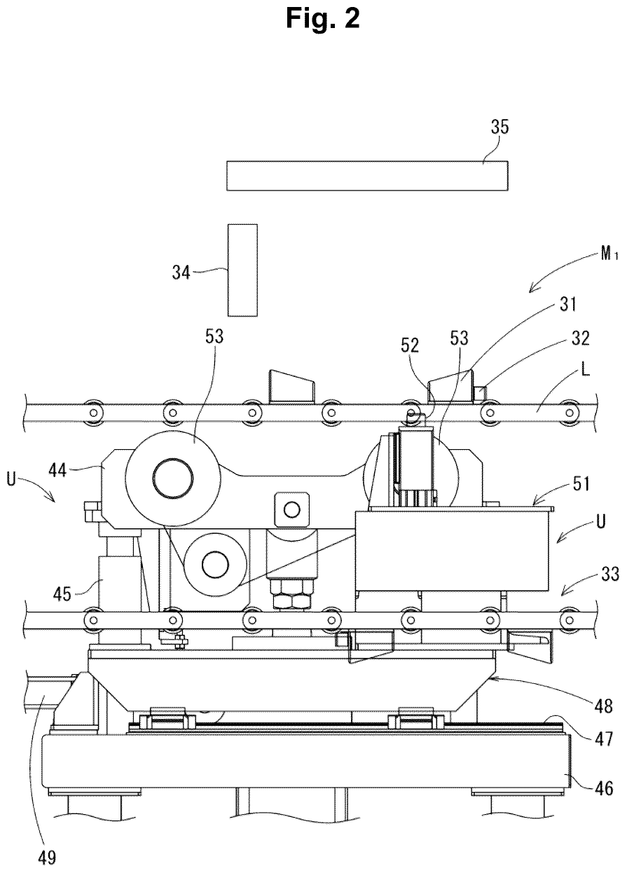

As in FIG. 1, the unbunging apparatus M include: an unbunging preparation device M1 for fixing the barrel B in a state where the barrel hole H faces directly upward, and identifying the position of the barrel plug T; and a barrel plug pull-out device M2 for pulling out the barrel plug T from the barrel B fixed by the unbunging preparation device M1, on the upstream side. FIG. 2 illustrates the unbunging preparation device M1. The unbunging preparation device M1 includes: a lifting-and-rotating device (lifting-and-rotating unit) 33 which is a lifting/lowering device for lifting the barrel B placed on the conveyance lines L and rotating the lifted barrel B; a centering unit 34 which detects a center in a lateral direction (a width direction of the conveyance lines L) of the barrel B and a center in a height direction (a height direction of the barrel B in the laterally laid-down state) of the barrel B in a state where the lifting-and-rotating device 33 has lifted and rotated the barrel B; a barrel plug detection unit 35 which detects the barrel plug T; and the like.

The lifting-and-rotating device 33 is installed to be located substantially directly below the barrel B (the barrel B in the laterally laid-down state) conveyed on the conveyance lines L and is composed of: a fixed base 46; a rail 47 provided on the upper surface of the base 46 to extend along the longitudinal direction of the conveyance lines L; a movable member 48 provided on the rail 47 to be movable along the longitudinal direction of the conveyance lines L; and the like. The movable member 48 includes: a lift unit 44 which is elevated to lift the barrel B and is lowered; a cylinder 45 which is a drive device for elevating and lowering the lift unit 44; rotators 53 pivotally attached to the lift unit 44 in a rotatable manner in a state of being arranged in two front and rear rows and two left and right rows; and the like. The barrel plug detection unit 35 is configured to take, by using a camera having an image processing function, an image of the center in the lateral direction of the barrel B detected by the centering unit 34 and ascertain a difference in color between the barrel plug T and the body of the barrel B in the image, thereby being able to distinguish the barrel plug T and the body of the barrel B from each other and detect (identify the position of) the barrel plug T.

In addition, the lifting-and-rotating device 33 is mounted with a position correction unit U composed of: a positioning unit 51 which accurately positions the movable member 48 with respect to one of the sets of front and rear reception claw members 31 provided on the conveyance lines L of a chain conveyor type; a cylinder 49 which moves the movable member 48 rearward and frontward with respect to the conveyance lines L; and the like. The positioning unit 51 is located outward of a rotator 53 on the front side of the lift unit 44 and has an upper end on which a positioning protrusion 52 is provided to be protrusile and retractable in the vertical direction by an elastic member (not illustrated). The cylinder 49 is configured to be able to slide the movable member 48 rearward and frontward along the rail 47 provided on the base 46.

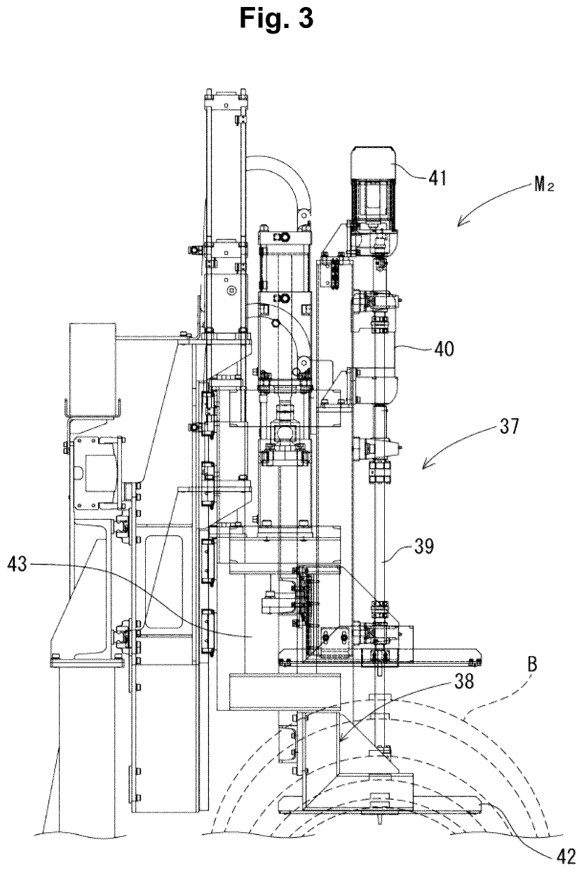

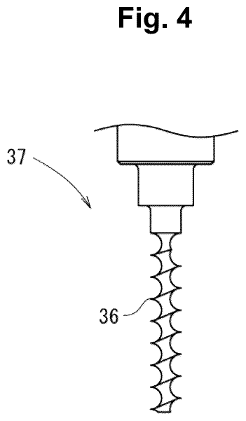

FIG. 3 illustrates the barrel plug pull-out device M2. The barrel plug pull-out device M2 includes: an unbunging unit 37 including a vertically provided spindle 39 having an end provided with a drill 36 which sticks the barrel plug T; a drive device (motor) 41 which rotates the spindle 39 about a vertical axis; a cylinder 40 which moves the spindle 39 upward and downward; a pressing-and-holding unit 38 which presses the barrel B to prevent the barrel B from being lifted together with the drill 36 when being unbunged; and the like. FIG. 4 illustrates the drill 36. The drill 36 is of a screw type in which a substantially strip-shaped drill blade is helically wound along an axis such that the drill is tapered from the base end toward the point thereof. The drill 36 has a narrowing angle adjusted to a predetermined angle (about) 2.5°. The pressing-and-holding unit 38 has: a pressing-and-holding member 42 having a bifurcated lower side for pressing and holding portions located leftward and rightward of the barrel plug T (upward and downward of the barrel plug T on the barrel B) during unbunging; and a cylinder 43 which applies downward pressure to the pressing-and-holding member 42.

### <Details of Operation of Conveyance Apparatus for Barrel>

### [Position Correction by Position Correction Unit]

In the conveyance apparatus C, as in FIG. 1, each of the barrels B is conveyed in a state of being laterally laid down on the conveyance lines L of a chain conveyor type (in a state where the height direction is orthogonal to a flow direction) and in a state of being fixed by one of the sets of reception claw members 31. When the barrel B is conveyed to the detection station S1 in the area in which the unbunging apparatus M is installed, the conveyance lines L are temporarily stopped and the laterally laid-down barrel B is placed on the lifting-and-rotating device 33 (on the four rotators 53 of the lift unit 44) of the unbunging preparation device M1 and is lifted above the conveyance lines L in order to perform preparatory work for unbunging.

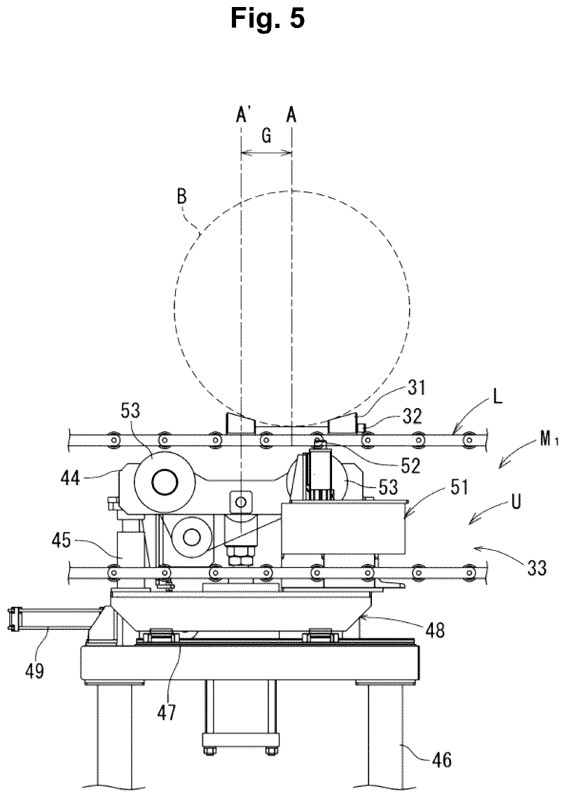

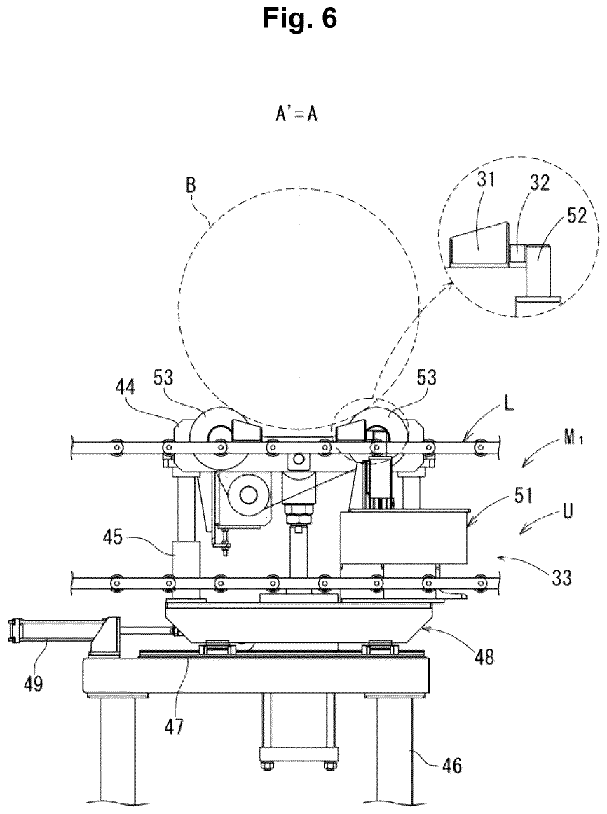

FIG. 5 and FIG. 6 illustrate states where the lifting-and-rotating device 33 (lift unit 44) lifts the barrel B. When the lifting-and-rotating device 33 lifts the barrel B, position correction for matching a center position A between the set of front and rear reception claw members 31 provided on the conveyance lines L and a center position A′ between the rotators 53 of the lifting-and-rotating device 33 is performed such that the barrel B is lifted in a stable state. The reason why such position correction is needed is because the center position A between the set of front and rear reception claw members 31 and the center position A′ between the rotators 53 of the lifting-and-rotating device 33 might be displaced from each other (a gap G might be formed therebetween) owing to, for example, elongation of chains constituting the conveyance lines L (elongation due to, for example, abrasion at a joint portion between the chains) (the state in FIG. 5).

The position correction unit U performs the position correction as follows. First, the cylinder 49 pushes the movable member 48 frontward (slides the movable member 48 frontward along the rail 47 provided on the base 46) such that the positioning protrusion 52 of the positioning unit 51 of the lifting-and-rotating device 33 is located downstream of the provision position of the positioning member 32 of a reception claw member 31 on the downstream side out of the set of front and rear reception claw members 31. When the movable member 48 is thus pushed frontward, the positioning protrusion 52 of the positioning unit 51 protrudes upward. Consequently, as in FIG. 6, the positioning protrusion 52 comes into contact with the positioning member 32 located frontward of the reception claw member 31 on the downstream side.

When the positioning protrusion 52 thus protrudes and comes into contact with the positioning member 32, the cylinder 49 stops operation, whereby the movable member 48 is stopped. The lifting-and-rotating device 33 is configured to allow the center position A′ between the rotators 53 to match the center position A between the set of front and rear reception claw members 31 at the front-rear position at which the positioning protrusion 52 having protruded comes into contact with the positioning member 32 of the reception claw member 31 on the downstream side. Therefore, the position correction is completed when the positioning protrusion 52 having protruded comes into contact with the positioning member 32 of the reception claw member 31 on the downstream side.

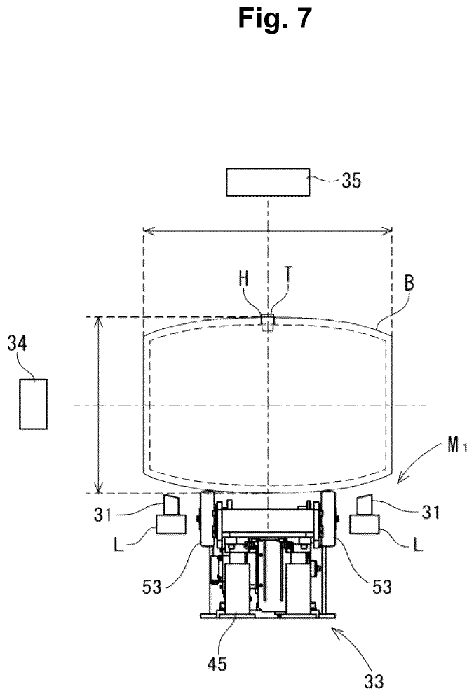

When the position correction is completed as described above, the cylinder 45 elevates the lift unit 44 of the lifting-and-rotating device 33 (i.e., lifts the barrel B) in a state where the laterally laid-down barrel B is placed on the four rotators 53 on the front, rear, left, and right sides. Thereafter, as in FIG. 7, while a drive device (not illustrated) is driving the rotators 53 to rotate the barrel B, the centering unit 34 positions the center in the lateral direction of the barrel B and the center in the rotation direction of the barrel B (i.e., performs centering) by fully utilizing a sensing technique and an image processing technique. Then, while the centering unit 34 is thus positioning the center in the lateral direction of the barrel B and the center in the rotation direction of the barrel B, the barrel plug detection unit 35 (the camera having an image processing function) detects the position of the barrel plug T, and the rotators 53 are driven via a controller, whereby the barrel plug T is located exactly at the top.

After the barrel plug T is located exactly at the top as described above, the cylinder 45 of the lifting-and-rotating device 33 is operated to lower the lift unit 44. Consequently, the barrel B is placed on the conveyance lines L to enter a state of being fixed by the set of reception claw members 31. As described above, the movable member 48 of the lifting-and-rotating device 33 has been accurately positioned with respect to the set of reception claw members 31 on the conveyance lines L. Therefore, the barrel B is placed on the conveyance lines L while being kept in a state where the barrel plug T is located exactly at the top. In addition, when the barrel B is placed on the conveyance lines L as described above, the cylinder 49 returns the movable member 48 rearward (slides the movable member 48 rearward along the rail 47 provided on the base 46) in order to prepare for detection of a barrel B to be conveyed next.

### [Unbunging by Unbunging Apparatus]

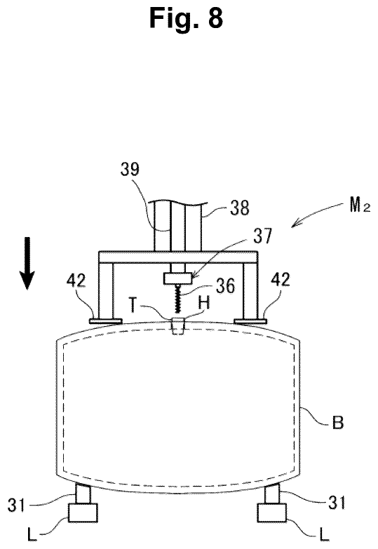

After the barrel B is placed on the conveyance lines L in a state where the barrel plug T is located exactly at the top as described above, the conveyance lines L are moved to move the barrel B to the unbunging station S2 as in FIG. 8. When the barrel B arrives at the unbunging station S2, the cylinder 40 lowers the spindle 39 of the unbunging unit 37 of the barrel plug pull-out device M2 so that the drill 36 at the end approaches the barrel plug T. Thereafter, the drill 36 at the end is screwed into the barrel plug T while being rotated by the drive device 41.

After the drill 36 is sufficiently screwed into the barrel plug T (caused to penetrate the barrel plug T), the cylinder 40 elevates the spindle 39 of the unbunging unit 37 to pull out the barrel plug T. When the barrel plug T is thus pulled out with the barrel plug T being in close contact with the barrel B, the barrel B might also be lifted together with the spindle 39. In order to avoid such a situation, while the unbunging unit 37 is performing the unbunging, the cylinder 43 lowers the pressing-and-holding members 42 so that the pressing-and-holding unit 38 presses and holds portions located near (leftward and rightward of) the barrel plug T into which the drill 36 has bitten. Consequently, the situation in which barrel B is lifted is prevented. After the unbunging is performed as described above, the conveyance lines L are operated (moved) again to convey the barrel B to an injecting/ejecting station S3 in order for the injecting/ejecting apparatus 1 to inject a liquid (newly-made liquor) into the barrel B or eject a liquid (aged liquor) from inside the barrel B.

### <Effects of Unbunging Apparatus>

As described above, the unbunging apparatus M includes: the lifting-and-rotating device (lifting-and-rotating unit) 33 which rotates the barrel B in a state where the barrel B has been lifted above the conveyor (the conveyance lines L of a chain conveyor type); the barrel plug detection unit 35 which detects the position of the barrel plug T; and the unbunging unit 37 having an end provided with the drill 36 which pulls out the barrel plug T. Consequently, the unbunging apparatus M makes it possible to automatically pull out the barrel plug T from the barrel B without need for hand work by a worker, whereby barreling work and draw-out work can be efficiently performed in a production process for whiskey or the like.

In addition, the unbunging apparatus M includes the pressing-and-holding unit 38 which presses the barrel B to prevent the barrel from being lifted together with the drill 36 when the barrel plug T is being pulled out by the drill 36. Consequently, the barrel plug T can be pulled out from the barrel B smoothly with high accuracy without allowing occurrence of, for example, displacement of the barrel B in association with unbunging work.

Furthermore, the unbunging apparatus M includes the centering unit 34 which detects the center in the lateral direction of the barrel B and the center in the rotation direction of the barrel B in a state where the lifting-and-rotating device (lifting-and-rotating unit) 33 has lifted the barrel B above the conveyor and has rotated the barrel B. Consequently, even in a case where the sizes differ among barrels B which are conveyed, the barrel plug detection unit 35 can considerably accurately detect the position of each of the barrel plugs T thereof, whereby the drill 36 can be assuredly stuck into (pressed against) the barrel plug T with higher accuracy.

Moreover, in the unbunging apparatus M, the drill 36 has a narrowing angle adjusted to a predetermined angle (about) 2.5°. Consequently, the drill 36 can be smoothly caused to bite into the barrel plug T, whereby the barrel plug T can be assuredly pulled out from the barrel B with higher accuracy.

Also, in the unbunging apparatus M, the pressing-and-holding unit 38 presses the barrel B in a direction (downward direction) opposite to a direction (upward direction) in which the barrel plug T is pulled out by the drill 36, the pressing inhibiting the barrel B from being lifted. Consequently, the barrel plug can be assuredly pulled out smoothly with extremely high accuracy without allowing occurrence of, for example, displacement of the barrel in association with unbunging work. Therefore, automatic injection of a liquid (newly-made liquor) into the barrel B by the injecting/ejecting apparatus 1 and automatic ejection of a liquid (aged liquor) from inside the barrel B in a subsequent step are performed more smoothly by the unbunging apparatus M, whereby barreling work and draw-out work for whiskey or the like are performed extremely efficiently.

### <Modification of Barrel Unbunging Apparatus>

The barrel unbunging apparatus according to the present invention is not limited to the aspect of the above-described embodiment at all, and the configurations of the lifting-and-rotating unit, the centering unit, the barrel plug detection unit, the drill, the unbunging unit, the pressing-and-holding unit, and the like may be modified as necessary without departing from the gist of the present invention. For example, the pressing-and-holding unit is not limited to a pressing-and-holding unit for pressing and holding portions located leftward and rightward of the barrel plug of a barrel placed in a laterally-oriented state on the conveyor (upward and downward of the barrel plug on the barrel) as in the above-described embodiment. The pressing-and-holding unit may be modified to: a pressing-and-holding unit for pressing and holding portions located frontward and rearward of the barrel plug (leftward and rightward of the barrel plug on the barrel); a pressing-and-holding unit for pressing and holding portions located frontward, rearward, leftward, and rightward of the barrel plug; a pressing-and-holding unit for circumferentially pressing and holding a portion around the barrel plug; or the like.

Also, the drill of the unbunging unit is not limited to a drill of the screw type in which a substantially strip-shaped drill blade is helically wound along an axis such that the drill is tapered from the base end toward the point thereof as in the above-described embodiment. The drill may be of a different type such as a type in which a tapered wire is helically wound. However, in a case where the drill is of the screw type in which a substantially strip-shaped drill blade is helically wound along an axis such that the drill is tapered from the base end toward the point thereof, and the drill has a narrowing angle adjusted to 0 to 3°, an advantage is obtained in that a satisfactory unbunging function is obtained. Table 1 indicates results of examinations conducted by the inventors in relation to the difference in the unbunging function among various narrowing angles of drills of the above-described screw type (results of performing evaluation in three grades through visual observation in relation to screwing ability and penetrating ability at the time of screwing these drills into the same barrel plug with the same rotational force). This table 1 provides a finding that adjustment of the narrowing angle to 0 to 3° leads to a satisfactory unbunging function.

TABLE 1

| | | Penetrating | Overall |
|---|---|---|---|
| Narrowing Angle | Screwing Ability | Ability | Evaluation |
| 5° | Fair | Poor | Poor |
| 4° | Fair | Poor | Poor |
| 3° | Fair | Good | Fair |
| 2° | Good | Good | Good |
| 1° | Good | Good | Good |

Meanwhile, the conveyance apparatus mounted with the unbunging apparatus is not limited to a conveyance apparatus in which preparatory work for unbunging, unbunging work, and content ejection/injection work are performed at different positions (stations). The conveyance apparatus may be modified to: a conveyance apparatus in which two or more of the preparatory work for unbunging, the unbunging work, and the content ejection/injection work are performed at the same position; or a conveyance apparatus in which all of the preparatory work for unbunging, the unbunging work, and the content ejection/injection work are performed at the same position.

### INDUSTRIAL APPLICABILITY

The barrel unbunging apparatus according to the present invention exhibits the excellent effects as described above, and thus is preferably usable as an apparatus for constructing automatic conveyance lines for whiskey barrels or the like.

### DESCRIPTION OF REFERENCE SIGNS

33: lifting-and-rotating device (lifting-and-rotating unit)
34: centering unit
35: barrel plug detection unit
36: drill
37: unbunging unit
38: pressing-and-holding unit
L: conveyance line
C: conveyance apparatus
M: unbunging apparatus
M₁: unbunging preparation device
M₂ barrel plug pull-out device
B: barrel
T: barrel plug
H: barrel hole

What is claimed is:

1. A barrel unbunging apparatus configured to pull out a barrel plug from a barrel placed in a laterally-oriented state on a conveyor of a conveyance line, the barrel unbunging apparatus comprising:
a lifting-and-rotating unit configured to rotate the barrel in a state where the barrel has been lifted above the conveyor;
a barrel plug detection unit configured to detect a position of the barrel plug; and
an unbunging unit having an end provided with a drill configured to pull out the barrel plug.

2. The barrel unbunging apparatus according to claim 1, further comprising
a pressing-and-holding unit configured to press the barrel to prevent the barrel from being lifted together with the drill when the barrel plug is being pulled out by the drill.

3. The barrel unbunging apparatus according to claim 1, further comprising
a centering unit configured to detect a center in a lateral direction of the barrel and a center in a rotation direction of the barrel in a state where the lifting-and-rotating unit has lifted the barrel above the conveyor and has rotated the barrel.

4. The barrel unbunging apparatus according to claim 1, wherein
the drill has a narrowing angle adjusted to 0 to 3°.

5. The barrel unbunging apparatus according to claim 2, wherein
the pressing-and-holding unit presses the barrel in a direction opposite to a direction in which the barrel plug is pulled out by the drill, the pressing inhibiting the barrel from being lifted.
